(19) United States
(12) Patent Application Publication
(10) Pub. No.: US 2007/0012565 A1
(43) Pub. Date: Jan. 18, 2007

(54) GAS DETECTION DEVICE, AND AIR-FUEL RATIO CONTROL DEVICE AND INTERNAL COMBUSTION ENGINE INCORPORATING THE SAME

(75) Inventors: Toshio SUZUKI, Iwata-shi, Shizuoka-ken (JP); Noriko SHII, Iwata-shi, Shizuoka-ken (JP); Kenji SETO, Iwata-shi, Shizuoka-ken (JP)

Correspondence Address: YAMAHA HATSUDOKI KABUSHIKI KAISHA;C/O KEATING & BENNETT, LLP, 8180 GREENSBORO DRIVE, SUITE 850, MCLEAN, VA, 22102, US

(73) Assignee: YAMAHA HATSUDOKI KABUSHIKI KAISHA, Iwata-shi (JP)

(21) Appl. No.: 11/456,885

(22) Filed: Jul. 12, 2006

(30) Foreign Application Priority Data
Jul. 12, 2005 (JP) 2005-203435

(51) Int. Cl. G01N 27/26

(52) U.S. Cl. 204/424

(57) ABSTRACT

A gas detection device includes a gas sensing portion, a heater, and an insulating layer provided between the gas sensing portion and the heater. The gas detection device further includes a control section and a portion of an engine control device for controlling operations of the gas sensing portion and the heater, the control section ensuring that timing of changing a current supplied to the heater is synchronized with a detection operation by the gas sensing portion. The gas detection device prevents detection errors of a gas sensor even when noise associated with temperature control of a heater occurs.

### BACKGROUND OF THE INVENTION

1. Field of the Invention

The present invention relates to a gas detection device, and in particular to a gas detection device which includes a heater for elevating the temperature of a gas sensing portion. The present invention also relates to an air-fuel ratio control device incorporating a gas detection device, and an internal combustion engine incorporating such an air-fuel ratio control device.

2. Description of the Related Art

From the standpoint of environmental issues and energy issues, it has been desired to improve the mileage of internal combustion engines, and reduce the emission amount of regulated substances (e.g., NOₓ) that are contained within exhaust gas emitted from internal combustion engines. In order to meet these needs, it is necessary to appropriately control the ratio between fuel and air in accordance with the state of combustion, so that fuel combustion will occur always under optimum conditions. The ratio of air to fuel is called an “air-fuel ratio” (A/F). In the case where a ternary catalyst is used, the optimum air-fuel ratio would be the stoichiometric air-fuel ratio. The “stoichiometric air-fuel ratio” is an air-fuel ratio at which air and fuel will combust just sufficiently.

When fuel is combusting at the stoichiometric air-fuel ratio, a certain amount of oxygen is contained within the exhaust gas. When the air-fuel ratio is smaller than the stoichiometric air-fuel ratio (i.e., the fuel concentration is high), the oxygen amount in the exhaust gas decreases relative to that under the stoichiometric air-fuel ratio. On the other hand, when the air-fuel ratio is greater than the stoichiometric air-fuel ratio (i.e., the fuel concentration is low), the oxygen amount in the exhaust gas increases. Therefore, by measuring the oxygen amount or oxygen concentration in the exhaust gas, it is possible to estimate how much deviation the air-fuel ratio has relative to the stoichiometric air-fuel ratio. This makes it possible to adjust the air-fuel ratio and control the fuel combustion so as to occur under the optimum conditions.

As oxygen sensors for measuring the oxygen concentration in exhaust gas, gas detection devices incorporating a resistance-type oxygen sensor are known, for example. Since a high temperature of 500° C. or above is needed for such an oxygen sensor to operate, a heater is provided near the oxygen sensor.

For example, Japanese Patent No. 3523937 discloses an oxygen sensor which incorporates a gas sensing portion and a heater.

Some oxygen sensors experience substantial fluctuations in their detection characteristics depending on the operating temperature. In such oxygen sensors, it is necessary to adjust the electric power to be supplied to the heater in order to control the sensor temperature to be within a predetermined range. However, the inventors have discovered that adjusting the sensor temperature based on ON/OFF control of the heater would make the gas detection device more liable to detection errors.

### SUMMARY OF THE INVENTION

In order to overcome the problems described above, preferred embodiments of the present invention provide a gas detection device which operates at a high detection accuracy while avoiding detection errors, as well as provide an air-fuel ratio control device and the like including such a gas detection device.

A gas detection device according to a preferred embodiment of the present invention includes a gas sensing portion, a heater, an insulating layer provided between the gas sensing portion and the heater, and a control section configured to control operations of the gas sensing portion and the heater so as to synchronize the timing of changing a current which is supplied to the heater with a detection operation by the gas sensing portion.

In a preferred embodiment, the gas sensing portion is preferably a resistance-type sensor.

In another preferred embodiment, the control section changes the current which is supplied to the heater in a period other than any period during which the detection operation by the gas sensing portion is executed.

In another preferred embodiment, the control section selectively executes an ON operation during which power is supplied to the heater for heating or an OFF operation during which power to the heater for heating is stopped, and the timing of switching the ON/OFF operations is shifted with respect to timing of the detection operation by the gas sensing portion.

In another preferred embodiment, the control section periodically switches between the ON operation and the OFF operation during a heating mode for increasing a temperature of the heater, and executes the OFF operation during a cooling mode for decreasing a temperature of the heater.

In another preferred embodiment, a period with which the ON operation and the OFF operation are switched during the heating mode is preferably about 50 milliseconds or less.

In another preferred embodiment, the control section controls the detection operation by the gas sensing portion to be periodically executed, and switches between the ON operation and the OFF operation of the heater while the detection operation is not being executed.

In another preferred embodiment, the control section controls the detection operation by the gas sensing portion to be executed in response to a signal which is periodically generated, and switches between the ON operation and the OFF operation of the heater after a predetermined period of time has elapsed since the signal is generated.

In another preferred embodiment, the detection operation by the gas sensing portion is preferably executed with a period of about 10 milliseconds or less.

In another preferred embodiment, an amount of time to elapse since a switching between the ON operation and the OFF operation is executed until a next instance of the detection operation by the gas sensing portion is executed is prescribed to be no less than about 500 microseconds and no more than about 2 milliseconds.

An air-fuel ratio control device according to a preferred embodiment of the present invention is an air-fuel ratio control device including a gas detection device, wherein the gas detection device includes a gas sensing portion, a heater, an insulating layer provided between the gas sensing portion and the heater, and a control section configured to control operations of the gas sensing portion and the heater so as to synchronize the timing of changing a current which is supplied to the heater with a detection operation performed by the gas sensing portion.

An internal combustion engine according to a preferred embodiment of the present invention is preferably an internal combustion engine including a gas detection device, wherein the gas detection device includes a gas sensing portion, a heater, an insulating layer provided between the gas sensing portion and the heater, and a control section configured to control operations of the gas sensing portion and the heater so as to synchronize the timing of changing a current which is supplied to the heater with a detection operation by the gas sensing portion.

According to preferred embodiments of the present invention, since the timing with which the current being supplied to the heater is changed is in synchronization with the detection operation by the gas sensing portion, a time difference is maintained therebetween. Therefore, the gas sensing portion is prevented from producing detection errors due to any electrical noise which occurs in response to changes in the current supplied to the heater. Thus, in accordance with the gas detection device, it is possible to perform highly accurate gas concentration measurement while controlling the heater temperature within an appropriate range.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an exploded perspective view showing an example of an oxygen sensor element used for a preferred embodiment of a gas detection device according to the present invention.

FIG. 2A is a schematic cross-sectional view of the oxygen sensor shown in FIG. 1. FIG. 2B is a schematic cross-sectional view showing another cross-sectional structure for the oxygen sensor.

FIG. 3 is a block diagram showing the construction of an engine control device in conjunction with a preferred embodiment of the gas detection device of the present invention.

FIG. 4 is a circuit diagram showing the construction of a resistance measurement circuit in a preferred embodiment of the present invention.

FIG. 5A is a flowchart showing a procedure of sensor resistance measurement which is performed in a preferred embodiment of the present invention.

FIG. 5B is a diagram showing a reference resistor switching algorithm in the resistance measurement circuit.

FIG. 6A is a block diagram showing the construction of a resistance-voltage conversion circuit in a preferred embodiment of the present invention. FIG. 6B is a graph showing a relationship between the resistance value of a heater and heater temperature. FIG. 6C is a graph showing a relationship between a voltage which is input to an ADC (i.e., output of the resistance-voltage conversion circuit) and temperature. FIG. 6D is a graph showing a relationship between the heater temperature (temperature data) and the output (AD-converted value) of the ADC.

In FIG. 7, (a) is a graph showing changes over time in the heater temperature in a preferred embodiment of the present invention; (b) is a diagram showing a timing of measuring the resistance value of the gas sensor; (c) is a diagram showing ON/OFF of the heater; (d) is a diagram showing a timing of measuring the heater temperature; and (e), (f) and (g) are enlarged diagrams showing portions of (b), (c) and (d), respectively.

FIG. 8 is a flowchart showing a control procedure of the operation shown in FIG. 7.

FIG. 9 is a diagram showing a timing of turning the heater ON or OFF, and a timing of measuring the resistance value of a gas sensing portion.

FIGS. 10A and 10B are perspective views schematically showing a construction for affixing an oxygen sensor to an exhaust pipe, where FIG. 10A shows a protection cap unattached, and FIG. 10B shows a protection cap attached.

FIG. 11 is a cross-sectional view schematically showing a construction for affixing an oxygen sensor to an exhaust pipe.

FIG. 12 is a schematic diagram showing an exemplary motorcycle according to a preferred embodiment of the present invention.

FIG. 13 is a schematic diagram showing a control system of an engine in the motorcycle shown in FIG. 12.

### DETAILED DESCRIPTION OF PREFERRED EMBODIMENTS

Hereinafter, preferred embodiments of the present invention will be described with reference to the accompanying drawings.

The inventors have discovered that the aforementioned detection errors which occur in a gas detection device are caused by electrical noise that occurs during frequent switching of powering states (ON/OFF) of a heater.

In the known gas sensor which is disclosed in Japanese Patent No. 3523937, supra, a gas sensing portion and a heater are arranged so as to oppose each other with a substrate interposed therebetween. The temperature of the heater is controlled by switching an externally-supplied current (which hereinafter may be simply referred to as a “heater current”) to be ON or OFF.

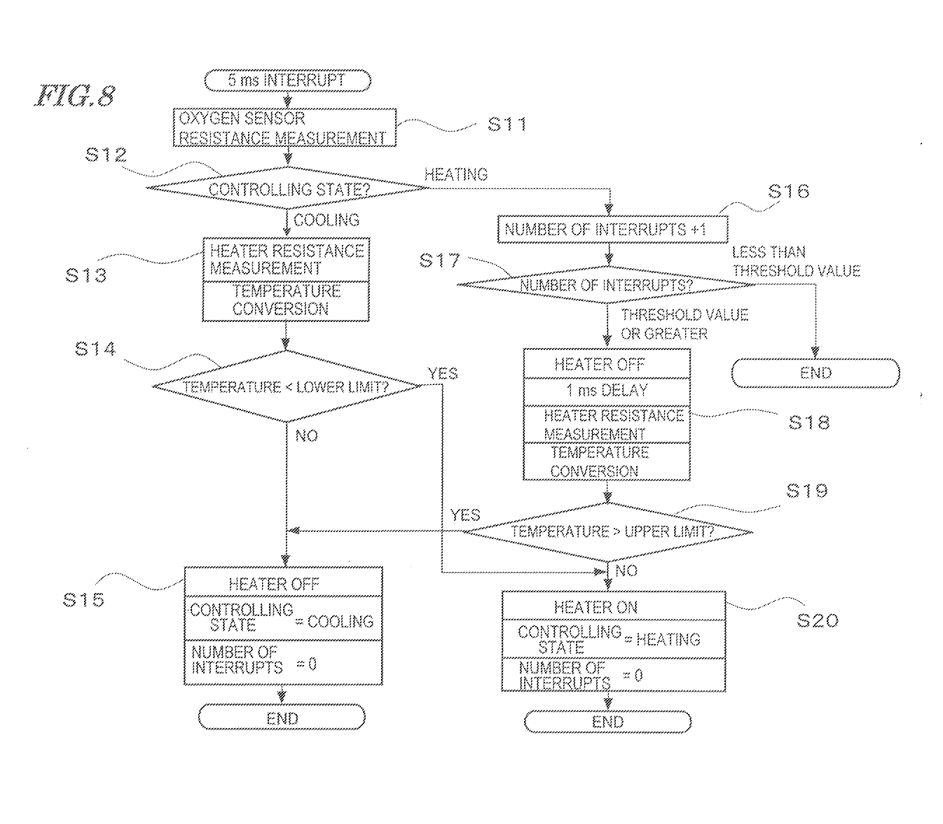

FIG. 9 is a timing chart schematically showing a relationship between the ON/OFF timing of a heater current (i.e., timing of changes in a current that is supplied to the heater) and the electrical noise that is induced in the electrodes and wiring that are connected to the gas sensing portion. As seen from FIG. 9, noise is observed when the heater transitions from an OFF state to an ON state, or from an ON state to an OFF state.

Such electrical noise does not occur while the heater current stays at a constant level, but occurs when the current drastically changes, i.e., in response to changes in the heater current. In the case where the gas sensing portion and the heater are disposed with a thin dielectric substrate (insulating layer) interposed therebetween, a parasitic capacitor is formed which causes capacitive coupling between the electrodes that are positioned on both sides of the substrate. Such capacitive coupling becomes stronger when the heater current undergoes rapid changes, thus inducing electrical noise in the gas sensing portion.

In the gas detection device according to the preferred embodiments of the present invention, a gas sensing portion performs a measurement operation in periods other than any period during which such electrical noise occurs (i.e., so as to avoid any period during which the heater current is turned ON or OFF).

Note that, in order to enhance the detection accuracy of a gas concentration, it is preferable to accurately detect the temperature of the gas sensing portion or the heater, and control the heater current in accordance with the detected temperature. In a preferred embodiment of the present invention, a heater whose resistance value changes with temperature is preferably used to detect the temperature of the heater.

### First Preferred Embodiment

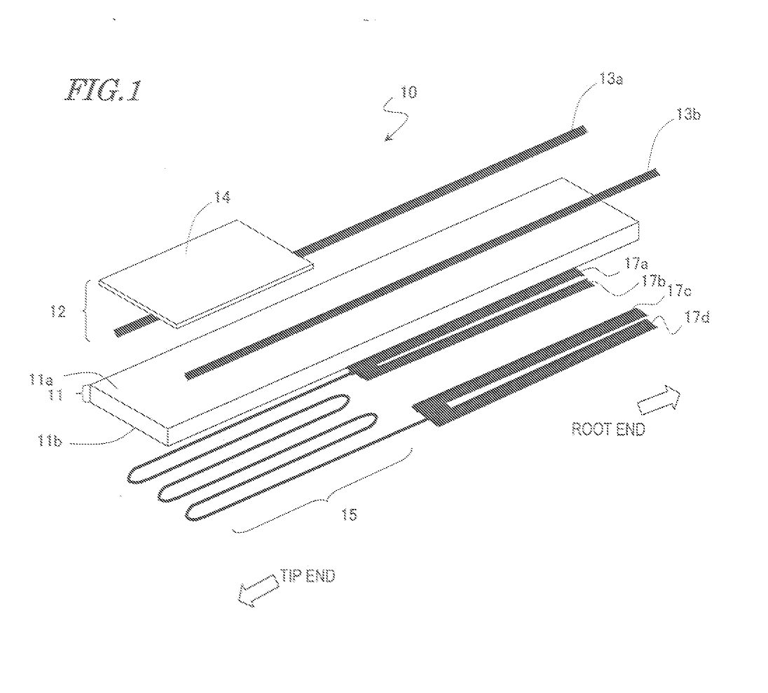

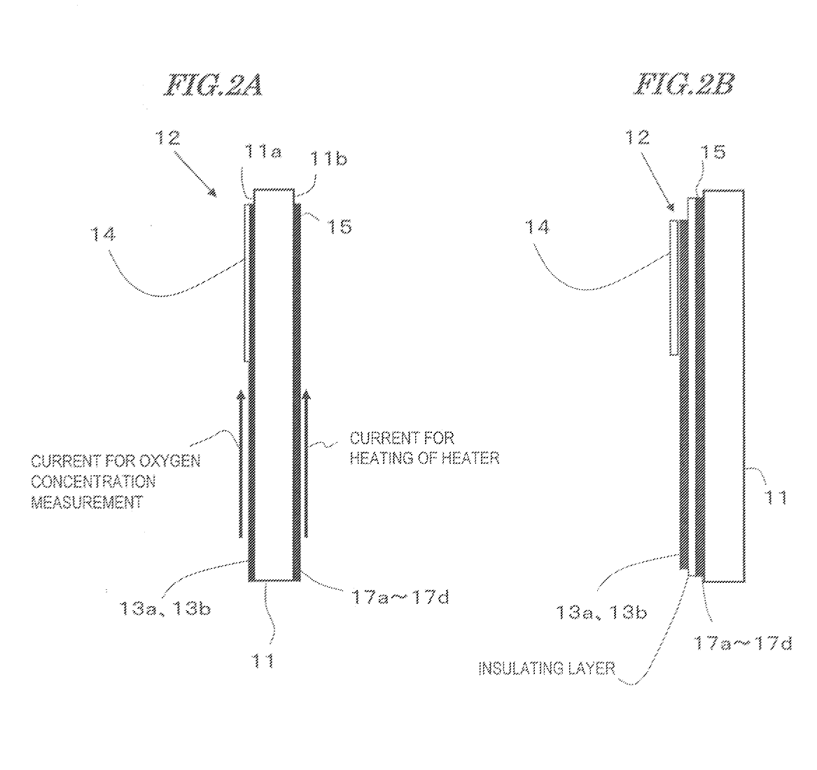

Hereinafter, a first preferred embodiment of a gas detection device according to the present invention will be described with reference to the drawings. First, referring to FIGS. 1, 2A, and 2B, an oxygen sensor 10 which is used in the gas detection device of the present preferred embodiment will be described. FIG. 1 is an exploded perspective view schematically showing the oxygen sensor 10. FIGS. 2A and 2B are cross-sectional views showing cross-sectional structures for the oxygen sensor 10.

As shown in FIG. 1, the oxygen sensor 10 includes a substrate 11 having a principal surface 11a and a rear surface lib opposing each other, and a gas sensing portion 12 which is provided on the principal surface 11a of the substrate 11.

The substrate 11, which is preferably made of an insulator such as alumina or magnesia, has an insulating surface. At a tip end of the substrate 11, the gas sensing portion 12 is provided. The root, or base, end of the substrate 11 is held by a member for affixing the oxygen sensor 10 to an exhaust pipe (e.g., a housing), as will be described later.

The “insulation” which is required of the substrate 11 to function as an insulating layer is defined as follows: when a voltage of about 10 V is applied between the principal surface 11a and the rear surface 11b of the substrate 11, a current of only about 1 mA or less (and preferably about 1 μA or less) flows between the surfaces. Note that the insulating layer does not need to be composed entirely of an insulator, but may be composed of a conductor or a semiconductor whose surface is coated with an insulator.

The gas sensing portion 12 detects the concentration or amount of a predetermined gas that is contained in the ambient gas which the gas sensing portion 12 comes in contact with. The gas sensing portion 12 in the present preferred embodiment is preferably a so-called resistance-type sensing portion, and includes a gas-sensitive layer 14 whose resistivity changes when the layer 14 comes in contact with a predetermined gas (e.g., oxygen in the illustrated example) that is contained in the ambient gas, and electrodes 13a and 13b which are provided in contact with the gas-sensitive layer 14.

The gas-sensitive layer 14 is preferably made of an oxide semiconductor layer, for example. The oxide semiconductor layer releases or absorbs oxygen in accordance with the oxygen partial pressure in the ambient gas. As a result, the oxygen vacancy concentration in the oxide semiconductor layer changes, whereby the resistivity of the oxide semiconductor layer changes. By measuring the changes in resistivity by utilizing the electrodes 13a and 13b, an oxygen concentration can be detected. The oxide semiconductor layer to be used as the gas-sensitive layer 14 is preferably made of a material such as cerium oxide, titanium oxide, or gallium oxide, for example. The construction of a resistance-type oxygen sensor is specifically described in for example, US2005/0236271 A1, the entire disclose of which is incorporated herein by reference.

The electrodes 13a and 13b are provided on the principal surface 11a of the substrate 11, and are covered with the gas-sensitive layer 14. Preferably, the electrodes 13a and 13b are arranged so as to oppose each other, in order to enable efficient measurement of changes in the resistivity of the gas-sensitive layer 14. The electrodes 13a and 13b are made of a material which is electrically conductive and which has a heat resistance similar to that of the substrate 11. It is particularly preferable that the electrodes 13a and 13b are made of a material whose melting point is higher than the temperature of a heat treatment which is conducted when forming the gas-sensitive layer 14, e.g., platinum, a platinum-rhodium alloy, or gold. As a method for forming the electrodes 13a and 13b, a screen printing technique can be used. As another method, any of the aforementioned materials may be formed into a film which extends over the entire principal surface 11a, via vapor phase deposition or the like, and thereafter the film may be patterned.

On the rear surface 11b of the substrate 11, a heater 15 for elevating the temperature of the gas sensing portion 12 is provided. As shown in FIG. 2A, the heater 15 is in a position corresponding to the gas sensing portion 12. That is, the heater 15 substantially overlies the gas sensing portion 12 via the substrate 11. Note that the substrate 11 preferably has a thickness which allows the heat generated in the heater 15 to flow quickly to the gas sensing portion 12. However, in order to obtain a sufficient rigidity and strength for retaining the gas sensing portion 12, the heater 15, and the like, the substrate 11 preferably has a thickness of no less than about 100 μm and no more than about 1.0 mm, for example.

Instead of the construction shown in FIG. 2A, a construction as shown in FIG. 2B may be used, where the heater 15 and the gas sensing portion 12 are stacked on the substrate 11 with an insulating layer (having a thickness between about 10 μm to about 500 μm) interposed therebetween. In this case, the thin insulating layer is present between the heater 15 and the gas sensing portion 12, not the substrate 11. By using a thin film deposition technique, the insulating layer is deposited over the substrate 11 so as to cover the heater 15. The insulating layer does not need to have a strong rigidity as does the substrate 11, and therefore may be thinner than the substrate 11.

The heater 15 in the present preferred embodiment is a heating element of a resistance heating type, which generates heat by utilizing a resistance loss that occurs when a current is passed through a resistor. The heater 15 is typically made of a metal material such as platinum or tungsten, or a conductive oxide such as rhenium oxide, and its resistance value changes with temperature.

Both ends of the heater 15 are connected to the electrodes 17a, 17b, 17c and 17d, as shown in FIG. 1. Among the four terminals (i.e., the electrodes 17a to 17d), for example, the electrodes 17a and 17d may be used for supplying electric power to the heater 15 while the electrodes 17b and 17c may be used for measuring the heater temperature by measuring the resistance value of the heater 15 (“four-terminal method”). Alternatively, only two electrodes (e.g., electrodes 17a and 17d) may be provided for both heating and resistance measurement. Preferably, the electrodes 17a to 17d are formed so as to be integral with the heater 15.

When a voltage is applied to the electrodes 17a and 17d and a current for heating is allowed to flow through the heater 15, the heater 15 generates heat whereby the gas sensing portion 12 becomes heated. By thus elevating the temperature of the gas sensing portion 12 using the heater 15, the gas sensing portion 12 is promptly activated whereby the detection accuracy at the start of an internal combustion engine can be improved. Since the detection sensitivity of the gas sensing portion 12 fluctuates with temperature, the present preferred embodiment uses a method which is described later to control the temperature of the gas sensing portion 12 so as to be within a predetermined range, thus maintaining a high detection accuracy of the gas concentration.

Via the electrodes 13a, 13b, and 17a to 17d, the oxygen sensor 10 of FIG. 1 is electrically connected to an engine control device not shown in FIG. 1. The engine control device controls the operations of the gas sensing portion 12 and the heater 15 in the oxygen sensor 10, and controls the gas sensing portion 12 at a temperature for obtaining proper operation, while also controlling various overall operations which are necessary for the measurement of gas concentration.

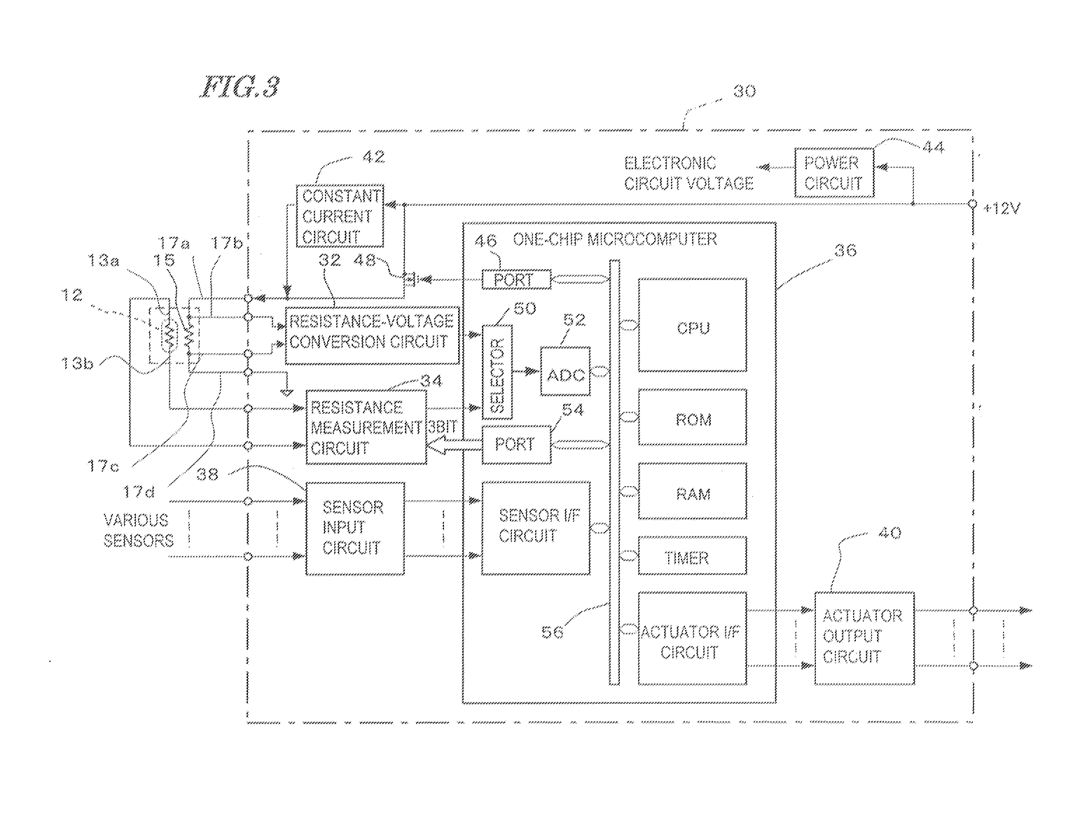

Next, referring to FIG. 3, the construction of the gas detection device of the present preferred embodiment will be described.

As shown in FIG. 3, the gas detection device of the present preferred embodiment includes a control section (which is implemented as a portion of an engine control device 30) for controlling the operations of the gas sensing portion 12 and the heater 15 described above. As shown in FIG. 1, the gas sensing portion 12 and the heater 15 oppose each other with the substrate 11 interposed therebetween, thus defining the oxygen sensor 10. As can be seen from FIG. 3, the gas sensing portion 12 is electrically connected to the engine control device 30 via the electrodes 13a and 13b, whereas the heater 15 is electrically connected to the engine control device 30 via the electrodes 17a to 17d.

The engine control device 30 includes a resistance-voltage conversion circuit 32 which is connected to the heater 15, a resistance measurement circuit 34 which is connected to the gas sensing portion 12, and a controller 36 which receives outputs from the resistance-voltage conversion circuit 32 and the resistance measurement circuit 34. The controller 36 of the present preferred embodiment is preferably composed of a one-chip microcomputer.

The engine control device 30 further includes a sensor input circuit 38 which is connected to various sensors (a throttle sensor, a water temperature sensor, etc., not shown), and the output of the sensor input circuit 38 is also supplied to the controller 36. The engine control device 30 includes an actuator circuit 40 which is connected to the controller 36. The output from the actuator circuit 40 controls the operations of various components of the engine.

The resistance-voltage conversion circuit 32, which is connected to the heater 15, measures the resistance value of the heater 15 and outputs a voltage which is in accordance with the measured resistance value (resistance-voltage conversion). The resistance value of the heater 15 is detected as a voltage drop at the heater 15 while a current of a predetermined level (“constant current”) is being supplied to the heater 15. Since the resistance value of the heater 15 depends on temperature, the temperature of the heater 15 can be detected from the measured resistance value. Since the heater 15 is in thermal contact with the gas sensing portion 12 via the thin insulating layer (substrate 11), by detecting the temperature of the heater 15 and controlling the heater temperature so as to be within a predetermined range, the temperature of the gas sensing portion 12 can also be controlled to be within an appropriate range.

As shown in FIG. 3, the engine control device 30 includes a constant current circuit 42 for supplying a constant current to the heater 15, and a power circuit 44 for generating a power voltage which is necessary for the operation of various electronic circuits in the engine control device 30, and the circuits are connected to a +12 V source power (e.g., a battery). The current which is supplied from the constant current circuit 42 to the heater 15 is not a current for heating the heater 15, but is a current to be used for measuring the resistance value of the heater 15.

A port 46 of the controller 36 controls a switch 48 so that the heater 15 is selectively connected to either the +12 V source power or the constant current circuit 42, via the electrodes 17a and 17d shown in FIG. 1. When heating the heater 15, the heater 15 is connected to the +12 V source power. On the other hand, when measuring the temperature of the heater 15, the switch 48 operates so that the source of the heater 15 is switched from the source power to the constant current circuit 42.

When the heater 15 is connected to the constant current circuit 42, a current of a predetermined level (e.g., a DC current of about 5 mA to about 50 mA) flows from the constant current circuit 42 to the heater 15 via the electrodes 17a and 17d. At this time, a differential amplification circuit (not shown in FIG. 3) within the resistance-voltage conversion circuit 32 and connected to the electrodes 17b and 17c measures a voltage across the heater 15. Since a below-described relationship exists between this voltage and the resistance value of the heater 15, it is possible to detect the temperature of the heater 15 (which corresponds to the temperature of the sensing portion) based on the measured voltage.

In the present specification, to “detect a heater temperature” does not necessarily mean ascertaining the actual numerical degree (° C.) of a heater temperature, but broadly means obtaining information concerning the temperature of the heater by detecting any parameter (e.g., a voltage) which changes in accordance with temperature.

The present preferred embodiment takes advantage of the property of the heater 15 that its resistance value changes with temperature, and converts the resistance value of the heater 15 first into a voltage. Then, based on this voltage, necessary calculations and control are performed. By ascertaining the correlation between the “temperature” and “resistance value” of the heater 15 and the “voltage” which is output from the resistance-voltage conversion circuit 32, it becomes possible to determine the number of degrees (° C.) of the actual temperature of the heater 15.

The output (i.e., a voltage corresponding to the resistance value of the heater 15) of the resistance-voltage conversion circuit 32, which is connected to the heater 15 via the electrodes 17b and 17c, is supplied to an AD converter (ADC) 52 of the controller 36 via a selector 50. The ADC 52 generates a digital value that corresponds to the voltage (analog value) which is output from the resistance-voltage conversion circuit 32 and outputs the digital value onto a data bus line 56 within the controller 36. The controller 36, which is preferably composed of a one-chip microcomputer as mentioned above, includes a CPU (central processing unit), a ROM (read-only memory), a RAM (random access memory), a timer, a sensor I/F (interface) circuit, an actuator I/F circuit, and the like. Transmission of instructions from the CPU and data, etc., that has been read from the ROM are handled via the data bus line 56. The sensor I/F circuit and the actuator I/F circuit, which include an AD converter and a timer port, etc., are connected to the sensor input circuit 38 and the actuator circuit 40, respectively.

When heat is output by the heater 15, the switch 48 operates so as to connect the heater 15 to the source power (+12 V), whereby a current for heating is supplied to the heater 15. Thus, the heater 15 in the present preferred embodiment is used not only as a “heating element”, but also as a “temperature detection element”.

On the other hand, an oxygen gas concentration can be detected by measuring the resistance value of the gas sensing portion 12 (or more precisely, the resistance value of the gas-sensitive layer 14) with the resistance measurement circuit 34. An output (voltage) of the resistance measurement circuit 34, which is connected to the gas sensing portion 12, is supplied to the ADC 52 via the selector 50 in the controller 36. From the ADC 52, a digital value (a value indicating an oxygen concentration) which corresponds to the output (analog data) of the resistance measurement circuit 34 is output onto the data bus line 56.

In the present preferred embodiment, the single ADC 52 is used for applying an AD conversion to the outputs of both the resistance-voltage conversion circuit 32 and the resistance measurement circuit 34. As described later, in the present preferred embodiment, it is ensured that the timing of measuring the resistance value of the heater 15 never coincides with the timing of measuring the resistance value of the gas sensing portion 12. As a result, based on the switching operation of the selector 50, it is possible to efficiently perform various AD conversions by using the single ADC 52.

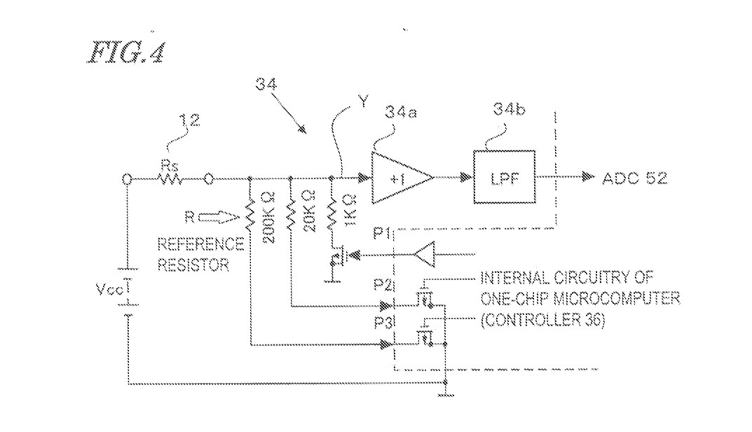

Next, referring to FIG. 4, the construction and operation of the resistance measurement circuit 34 used for the detection of the resistance value (Rs) of the gas sensing portion 12 will be described more specifically.

As described above, the gas sensing portion 12 of the present preferred embodiment includes the gas-sensitive layer 14, whose resistance value Rs changes in accordance with the concentration of oxygen gas. Based on the resistance value Rs of the gas-sensitive layer 14, the oxygen gas concentration can be detected. In the case of a resistance-type gas sensor, the resistance value Rs of the gas-sensitive layer 14 varies across a wide range in accordance with an oxygen gas concentration. However, the dynamic range at the input side of the ADC 52 is limited. Therefore, in order to enhance the output resolution of the ADC 52, it is preferable to adjust a voltage (analog value) which is input from the resistance measurement circuit 34 to the ADC 52 so as to fall within an appropriate range. Therefore, in the resistance measurement circuit 34 of the present preferred embodiment, an optimum reference resistor is selected from among a plurality of reference resistors, thus improving the output resolution of the ADC 52.

As shown in FIG. 4, the resistance measurement circuit 34 applies a predetermined potential (Vcc) to one end of the gas sensing portion 12 (having a resistance value Rs), and electrically connects the other end of the gas sensing portion 12 to a reference resistor which is selected from among a plurality of reference resistors. The three reference resistors in the present preferred embodiment preferably have resistance values of about 200 kΩ, about 20 kΩ, and about 1 kΩ. However, this is not the only possible set of resistance values that can be used.

The reference resistors are connected to the controller 36 via ports P1, P2 and P3 (corresponding to the port 54 in FIG. 3). To gates of three MOS transistors shown in FIG. 4, 3-bit data which has been generated in the controller 36 is applied. Based on this 3-bit data, only one of the three MOS transistors will conduct, whereby the one reference resistor that is connected to the conducting MOS transistor is selected.

Via the reference resistor which has been thus selected, a current flows through the gas sensing portion 12 (resistance value Rs). Since the potential Vcc is divided between a resistance value R of the reference resistor and the resistance value Rs of the oxygen sensor, the following equation holds true, where “Y” represents a potential at the connection point between the reference resistor and the gas sensing portion 12.
Y=Vcc·R/(Rs+R) (eq. 1)

Herein, Rs represents the resistance value of the gas sensing portion 12, whereas R represents the resistance value (200 kΩ, 20 kΩ, or 1 kΩ) of the selected reference resistor.

As shown in FIG. 4, the potential Y is input to the ADC 52, via an operational amplifier 34a and the low-pass filter (LPF) 34b functioning as a buffer. Since eq. 1 can be transformed into eq. 2 below, the resistance value Rs can be determined from the potential Y.
Rs=R·(Vcc−Y)/Y (eq. 2)

By mapping Vcc to “1023=2¹⁰−1”, and assuming that the potential Y is converted to a digital value X through the AD conversion by the ADC 52, eq. 3 is obtained as follows.
Rs=R·(1024−X)/X (eq. 3)

As can be seen from eq. 3, once the output (digital value X) of the ADC 52 is determined, the resistance value Rs can be determined based on the resistance value R of the selected reference resistor. Once the resistance value Rs is determined, the oxygen concentration can be ascertained.

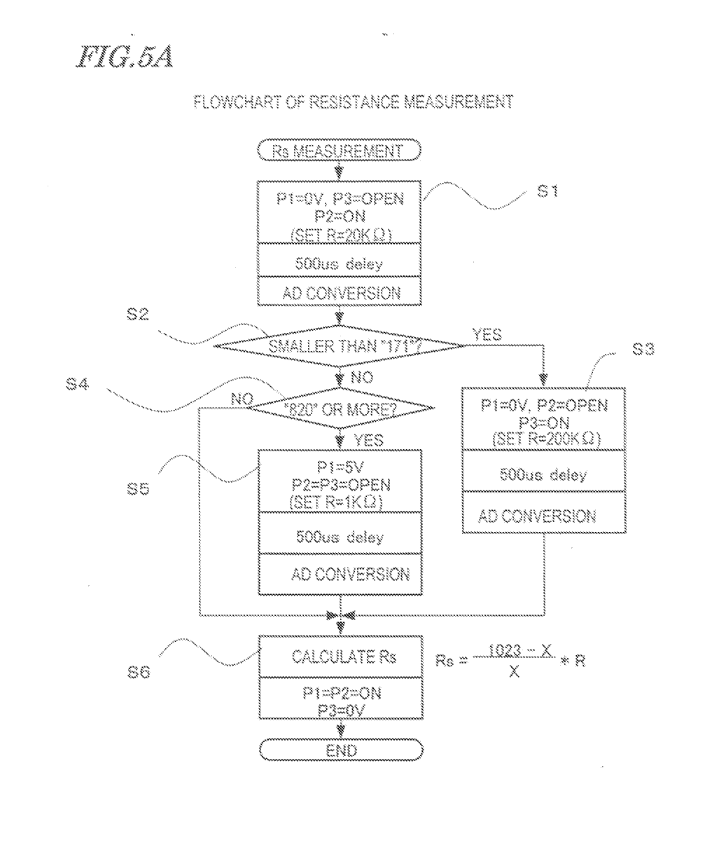

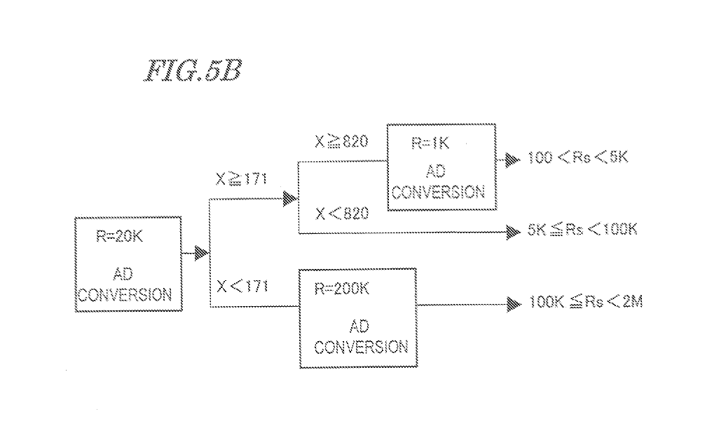

FIG. 5A is a flowchart of resistance measurement. FIG. 5B is a flowchart showing switching of reference resistors.

First, as shown in FIG. 5A, the 20 kΩ reference resistor is selected (step S1). Specifically, a potential of 0 V is supplied to the port P1 shown in FIG. 4, and the MOS transistor at the port P2 is allowed to conduct, while the MOS transistor at the port P3 is kept non-conducting. As a result of this, the 20 kΩ reference resistor is selected. A current flows through the selected 20 kΩ reference resistor and the gas sensing portion 12 (having the resistance value Rs), and the potential Vcc is divided between these resistances. As shown in FIG. 4, the potential Y at the connection point between the gas sensing portion 12 and the reference resistor is input to the ADC 52 via the buffer 34a and the LPF 34b, and converted to a digital value (AD conversion). As the digital value to be obtained through the AD conversion, it is preferable to use a value which is obtained when a predetermined period of time has elapsed since starting the measurement operation of the resistance value Rs. In the present preferred embodiment, a value which is obtained when about 500 microseconds (us) have elapsed since starting the measurement operation of the resistance value Rs is used.

Next, at step S2, it is determined whether the digital value (output X of the ADC 52) which is obtained through the AD conversion is smaller than “171” or not. If the output X of the ADC 52 is smaller than “171” (“YES”), control proceeds to step S3, and the reference resistor is switched from the 20 kΩ reference resistor to the 200 kΩ reference resistor. Specifically, a potential of 0 V is supplied to the port P1 shown in FIG. 4, and while keeping the MOS transistor at the port P2 non-conducting, the MOS transistor at the port P3 is allowed to conduct. As a result of this, the 200 kΩ reference resistor is selected. A current flows through the selected 200 kΩ reference resistor and the gas sensing portion 12 (having the resistance value Rs), and the potential Vcc is divided between these resistances. Thereafter, an AD conversion by the ADC 52 is performed, and control proceeds to step S6. At step S6, the sensor resistance value Rs is determined based on the output X of the ADC 52.

On the other hand, if step S2 finds that the output X of the ADC 52 is equal to or greater than “171” (“NO”), it is determined at step S4 as to whether or not the output X of the ADC 52 is equal to or greater than “820”. If it is determined that output X of the ADC 52 is equal to or greater than “820” (“YES”), control proceeds to step S5, and the reference resistor is switched from the 20 kΩ reference resistor to the 1 kΩ reference resistor, and an AD conversion by the ADC 52 is performed. Specifically, a potential of 5 V is supplied to the port P1 shown in FIG. 4, and the MOS transistors at the ports P2 and P3 are both kept non-conducting. As a result of this, the 1 kΩ reference resistor is selected. A current flows through the selected 1 kΩ reference resistor and the gas sensing portion 12 (having the resistance value Rs), and the potential Vcc is divided between these resistances. Thereafter, control proceeds to step S6, and the sensor resistance value Rs is determined based on the output X of the ADC 52.

If step S4 finds that the output X of the ADC 52 is smaller than “820” (“NO”), control proceeds to step S6, and the sensor resistance value Rs is determined based on the output X of the ADC 52.

As shown in FIG. 5B, based on the output X of the ADC 52, a reference resistor of an appropriate value can be selected. In the present preferred embodiment, the 1 kΩ reference resistor is selected when the resistance value Rs is greater than about 100 Ω and less than about 5 kΩ. The 20 kΩ reference resistor is selected when the resistance value Rs is equal to or greater than about 5 kΩ and less than about 100 kΩ. The 200 kΩ reference resistor is selected when the resistance value Rs is equal to or greater than about 100 Ω and less than about 2 MΩ.

Thus, according to the present preferred embodiment, even if the resistance value Rs of the gas sensing portion 12 greatly changes in the range from about 100 Ω to about 2 MΩ, a high-resolution AD conversion can be properly performed by using the single ADC 52. Therefore, the resistance value Rs can be detected with a high accuracy.

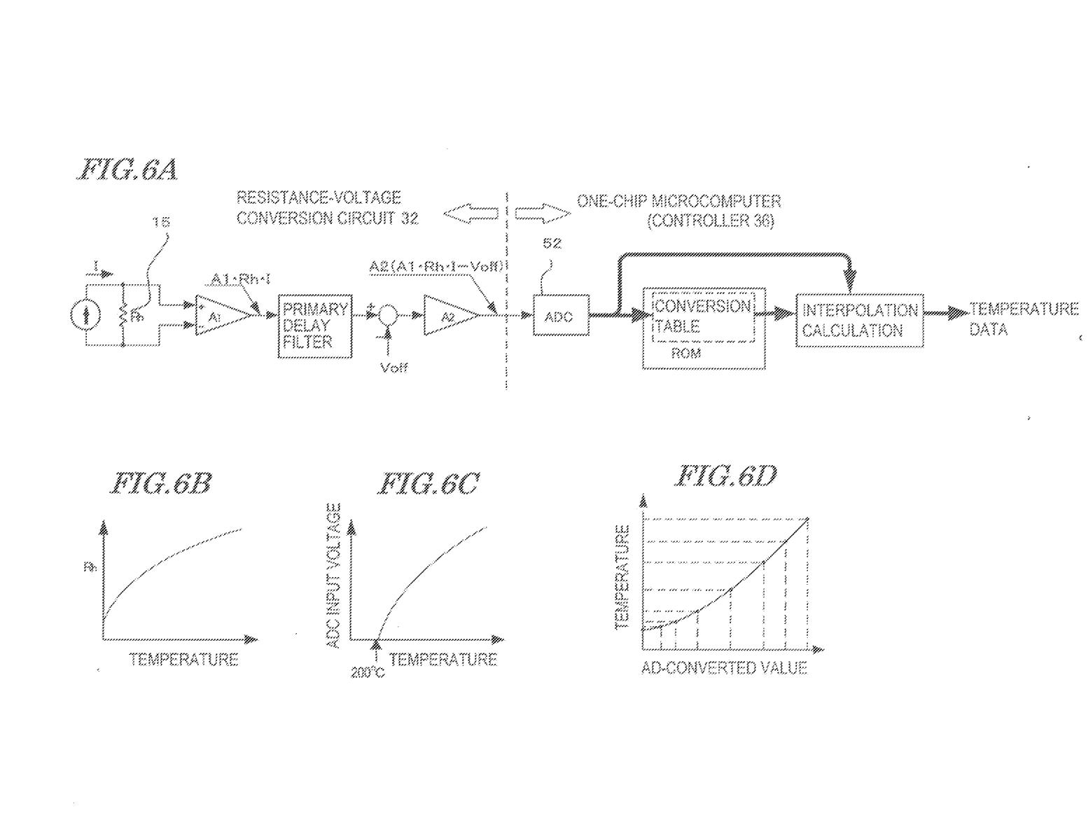

Next, with reference to FIGS. 6A to 6D, heater temperature measurement will be described.

A relationship as shown in FIG. 6B exists between a resistance value Rh of the heater and the heater temperature. As shown in FIG. 6A, when a constant current I flows through a heater having a resistance value Rh, a voltage (Rh·I) which is in accordance with the resistance value Rh is generated across the heater. This voltage is input to the first operational amplifier so as to be amplified by a factor A1, and thereafter, its noise component is removed by a primary delay filter. The voltage, now having a value which is represented as A1·Rh·I, receives an offset voltage V_{off}, and is input to a second operational amplifier. The second operational amplifier amplifies the voltage by a factor A2, and therefore produces an output having a value as represented by the following equation.
A2·(A1·Rh·I·V_{off}) (eq. 4)

Since the resistance value Rh exhibits a temperature dependence as shown in FIG. 6B, the output of the second operational amplifier exhibits a temperature dependence as shown in FIG. 6C. In this example, the offset voltage V_{off} is prescribed so that the output of the second operational amplifier becomes zero when the heater temperature is about 200° C.

A voltage whose value in accordance with temperature as shown in FIG. 6C is input to the ADC 52 of the controller 36 for AD conversion. FIG. 6D shows a relationship between the value obtained through the AD conversion (“AD-converted value”) and the heater temperature.

In the present preferred embodiment, a conversion table is preferably used to determine a temperature from an AD-converted value. The conversion table, which is stored in a ROM in the form of a look-up table, contains previously-ascertained data concerning correspondence between AD-converted values and temperatures. In the present preferred embodiment, instead of assigning temperature data to all possible AD-converted values, temperature data is only assigned to some specific AD-converted values. Therefore, for any intermediate value of AD change other than those specific AD-converted values, appropriate temperature data is to be determined through interpolation calculation.

FIG. 6D is a graph showing correspondence between AD-converted values and temperatures. Broken lines in the graph schematically indicate the relationship between AD-converted values which are recorded in the conversion table and their corresponding temperatures.

Note that the temperature dependence of the heater resistance Rh is not limited to that shown in FIG. 6B, but may be any relationship so long as a temperature is uniquely determinable from the heater resistance Rh. For example, the heater resistance Rh may decrease as the temperature increases.

Next, with reference to (a), (b), (c) and (d) of FIG. 7, resistance measurement for the gas sensing portion 12 and resistance value measurement/temperature control for the heater 15 will be described in detail.

In FIG. 7, graph (a) schematically shows changes over time in the heater temperature according to the present preferred embodiment. As can be seen from (a) of FIG. 7, in the present preferred embodiment, a two-position control for the heater is performed so that the heater temperature will remain within a temperature range defined by a temperature (“upper limit temperature”) which is about 20° C. higher than a setting value (e.g. 730° C.) and a temperature (“lower limit temperature”) which is about 20° C. lower than the setting value. The temperature controlling method is not limited to two-position control, but may be any other control method. The differences between the upper limit temperature and the lower limit temperature and the setting value (central value) are not limited to the aforementioned values.

Diagram (b) in FIG. 7 shows resistance measurement timing for the gas sensing portion 12 (which is performed for oxygen concentration measurement). As described above, the resistance measurement for the gas sensing portion 12 is performed by the resistance measurement circuit 34 shown in FIG. 4. This resistance measurement is repeated with a predetermined period (which is about 5 ms in the present preferred embodiment).

Diagram (c) in FIG. 7 shows ON/OFF operations of the heater 15. When heating the heater 15 to increase the heater temperature, a current (heating current) for heating is supplied to the heater 15 from the source power (+12 V) (“heating mode”). On the other hand, when heating of the heater 15 is stopped to allow the heater temperature to decrease, supply of the heating current to the heater 15 is stopped (“cooling mode”). The switching between heating/cooling modes is performed by the switch 48 shown in FIG. 3.

As can be seen from a comparison between diagrams (a) and (c) of FIG. 7, after operation is started, a heating current is supplied to the heater 15, and the heater 15 mainly takes an ON state, whereby the heater temperature keeps increasing (heating mode). Once the heater temperature reaches the upper limit temperature, supply of the heating current to the heater 15 is stopped, and the heater 15 transitions from the ON state to an OFF state (cooling mode). Thereafter, when the heater temperature has decreased to reach the lower limit temperature, supply of the heating current to the heater 15 is restarted (heating mode). Through a temperature control in which the heating mode and the cooling mode are repeated in this manner, the heater temperature is maintained within the predetermined temperature range shown in (a) of FIG. 7.

In the present preferred embodiment, supply of the heating current is shut off periodically and momentarily (about 1.3 ms or less in the present preferred embodiment) even while the heater temperature is increasing (heating mode). The reason for periodically turning OFF the heater 15 during the heating mode in this manner is the need to measure the heater temperature during the heating mode. As described earlier, in order to measure the heater temperature, it is necessary to measure the resistance value of the heater 15 by supplying a constant current (e.g., a current of about 20 mA) to the heater 15. Therefore, supply of the heating current to the heater 15 is periodically suspended, and the heater temperature is measured during this suspended period. Note that the amount of time required for measuring the heater temperature is short, and is about 0.3 ms or less in the present preferred embodiment. Since the amount of time during which supply of the heating current to the heater 15 is stopped can be kept at a sufficiently short value, the heater temperature during the heating mode keeps increasing without being affected by the periodic switching between ON/OFF operations.

On the other hand, during the cooling mode, as shown in diagram (c) of FIG. 7, the heater is continuously in an OFF state. Therefore, it is possible to measure the resistance value of the heater 15 at any arbitrary point in time. In the present preferred embodiment, however, the heater temperature is also detected with the predetermined period of about 5 ms during the cooling mode. Although a constant current must flow through the heater 15 in order to measure the heater temperature, this constant current is considerably smaller (about 10% or less) than the current for heating. Therefore, even if this current is constantly flowing through the heater 15 during the cooling mode, there are no unfavorable influences on the cooling action. Accordingly, during the cooling mode in the present preferred embodiment, this constant current is kept supplied to the heater 15, even when not measuring the resistance value of the heater 15.

Diagrams (e), (f) and (g) of FIG. 7 are enlarged (timewise) views showing portions of diagrams (b), (c) and (d) of FIG. 7, respectively. As can be seen from (e), (f) and (g) of FIG. 7, in the present preferred embodiment, there are offsets along the time axis between the timing with which the resistance value of the gas sensing portion 12 is measured, the timing with which the heater is turned ON or OFF, and the timing with which the temperature (resistance value) of the heater 15 is measured. This effect will be described later.

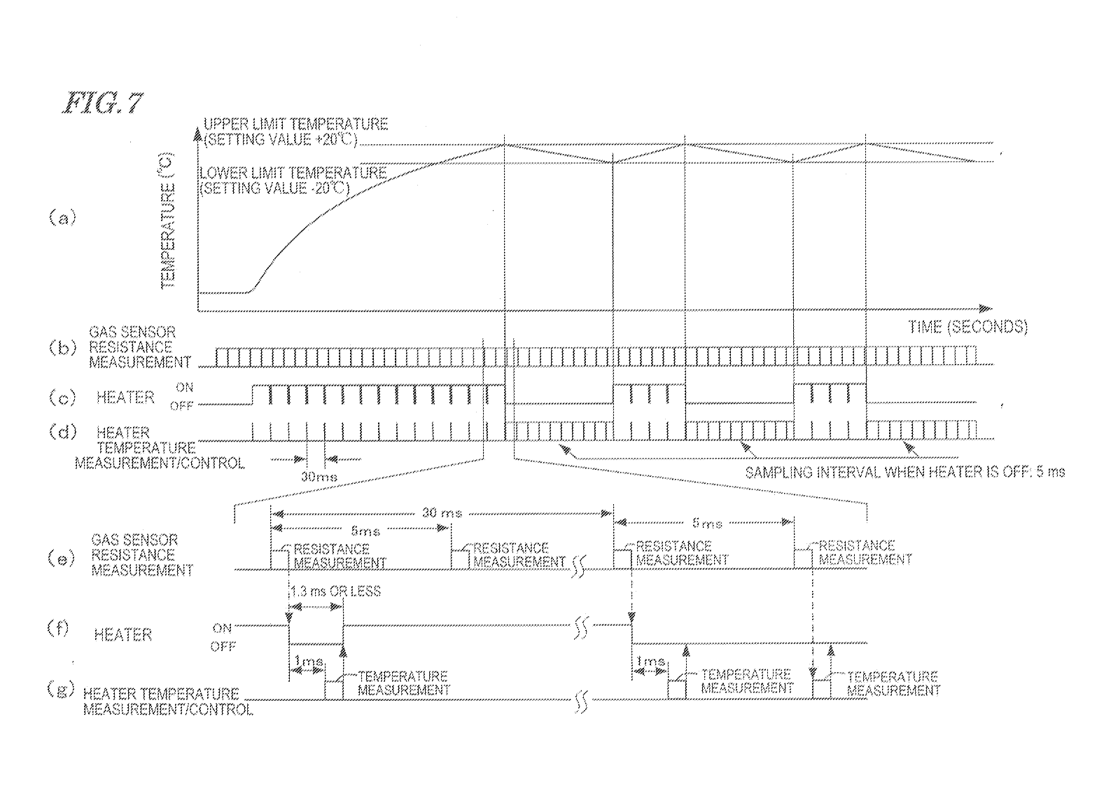

Next, mainly referring to FIG. 8, a flow of control of the gas sensor resistance and heater temperature measurements in the present preferred embodiment will be described in detail.

As shown in FIG. 8, while making an interruption every 5 ms, the resistance value of the gas sensing portion 12 is measured, and thereafter a sequence of processes as described below is executed in the present preferred embodiment. Each “interrupt” is to be made based on an interrupt signal which is generated by a controller 36 (see FIG. 3) in synchronization with a reference clock signal.

As shown in FIG. 8, when an interrupt is made, the resistance value of the gas sensing portion 12 is measured at step S11 (oxygen sensor resistance measurement). The resistance value of the gas sensing portion 12 is measured by the action of the resistance measurement circuit 34, as described above. Thereafter, the controlling state (i.e., the heating mode or the cooling mode) of the heater 15 is determined at step S12. If it is in the cooling mode, control proceeds to step S13, and the resistance value of the heater 15 is measured, whereby the heater temperature is determined (temperature conversion). The resistance value of the heater 15 is measured by the action of the resistance-voltage conversion circuit 32, as described above. As shown in the right-hand side of diagrams (e) and (g) of FIG. 7, each resistance measurement of the oxygen sensor is followed by a temperature measurement of the heater.

Thereafter, at step S14 shown in FIG. 8, it is determined whether the heater temperature is lower than a predetermined lower limit temperature or not. If the heater temperature is not lower than the limit temperature (“TNO” T), control proceeds to step S15. At step S15, while keeping the heater OFF, the controlling state is set to the “cooling mode”, and the number of interrupts is zeroed.

In the cooling mode, since interrupts are made at an interval of about 5 ms, the aforementioned operation will be repeated with a period of about 5 ms, unless the heater temperature becomes smaller than the lower limit temperature. In other words, the heater temperature is measured at an interval of about 5 ms in the cooling mode (see (d) of FIG. 7).

If step S14 finds that the heater temperature is lower than the lower limit temperature (“YES”), control proceeds to step S20. The operation of step S20 will be described later.

Next, the flow of control when the controlling state of the heater is determined to be in the “heating mode” at step S12 will be described. In this case, control proceeds to step S16, where the counter value of the number of interrupts is incremented. Thereafter, at step S17, it is determined whether the number of interrupts has increased to become equal to a predetermined threshold value or not. The threshold value is prescribed to be “6”, for example. If it is determined that the number of interrupts is smaller than the threshold value, control proceeds to “END”, and the next interrupt is awaited. By repeating this process, the counter value of the number of interrupts is incremented by one each time, until eventually reaching the threshold value.

If step S17 finds that the number of interrupts is equal to or greater than the threshold value, control proceeds to step S18. At step S18, the heater 15 is temporarily turned OFF. After a delay time of about 1 ms since the heater 15 was turned OFF, the resistance value of the heater 15 is measured and is converted to heater temperature data. As shown in the left-hand side of diagrams (e) to (g) of FIG. 7, a gap of about 1 ms exists between the ON/OFF switching timing of the heater 15 and the heater temperature measurement timing in the heating mode. Since the amount of time which is required for the temperature measurement/control of the heater 15 is not more than about 0.3 ms, the period of time during which the heater 15 is kept OFF can be reduced to about 1.3 ms or less.

Next, at step S19 shown in FIG. 8, it is determined whether the heater temperature is above the upper limit temperature or not. If it is determined that the heater temperature is not above the upper limit temperature (“NO”), control proceeds to step S20, where the controlling state of the heater 15 is set to the “heating mode”, and the counter value of the number of interrupts is zeroed. Thereafter, after receiving as many interrupts as the threshold value indicates, similar processes (heater temperature measurement, etc.) are performed. In the present preferred embodiment, the threshold value is set to “6”, so that temperature measurement of the heater 15 is performed with a period of 5 ms×6=30 ms. The threshold value may be any other integer.

Thus, while in the heating mode, the heater is periodically placed in an OFF state, and the heater temperature is measured during each short span of time in which the heater is in an OFF state. The period with which the heater temperature is measured in the heating mode does not need to be equal to the period (about 5 ms) with which the heater temperature is measured in the cooling mode, and is about 30 ms in the present preferred embodiment, as described above.

If step S19 finds that the heater temperature is above the upper limit (“YES”), control proceeds to step S15, where the controlling state of the heater is switched to the “cooling mode”. If step S14 in the cooling mode (described above) finds that the heater temperature is lower than the lower limit temperature (“YES”), control proceeds to step S20, and the controlling state of the heater is set to the “heating mode”. Thus, a two-position control for the heater temperature is performed, whereby the heater temperature is appropriately adjusted between the upper limit temperature and the lower limit temperature.

In the present preferred embodiment, oxygen concentration measurement by the gas sensing portion 12 and temperature measurement of the heater 15 are performed in synchronization with an interrupt signal which is generated with a period of about 5 ms. The time interval with which the oxygen sensor resistance is measured is about 5 ms. This time interval is prescribed so that the influence of any noise occurring upon an ON/OFF switching of the heater is sufficiently reduced to enable accurate oxygen sensor resistance measurements. Moreover, in the present preferred embodiment, as shown in diagrams (e) to (g) of FIG. 7, a time difference is introduced between the timing of gas sensor resistance measurement (oxygen concentration measurement) and the timing of turning the heater ON or OFF. Specifically, the oxygen sensor resistance is measured before an ON/OFF switching of the heater, and a next oxygen sensor resistance measurement is taken after the lapse of about 5 ms therefrom. Thus, after an ON/OFF switching of the heater, a sufficient amount of time elapses before a next measurement of the oxygen sensor resistance. Therefore, even if an electrical noise occurs in response to ON/OFF switching of the heater as shown in FIG. 9, there are no unfavorable influences on the measurement by the gas sensing portion 12. As a result of this, highly accurate oxygen concentration measurements are obtained. As will be understood from the above descriptions, in the present specification, the expression “in synchronization with” is used to describe two events occurring while retaining a specific time relationship, with a predetermined time difference between the two events, and does not mean that the two events occur simultaneously.

Electrical noise frequently occurs especially in the case where the ON/OFF switching of the heater 15 is periodically performed even during the heating mode (in order to enable resistance value measurement of the heater 15), as in the present preferred embodiment. In such a case, the effect of introducing a time difference between the timing of gas concentration measurement by the gas sensing portion 12 and the ON/OFF switching timing of the heater 15 becomes clearer. The time difference between the timing of gas concentration measurement by the gas sensing portion 12 and the ON/OFF switching timing of the heater 15 (i.e., the timing with which the heater current is changed) is preferably prescribed in a range of no less than about 500 microseconds (μs) and no more than about 2 milliseconds (ms), and more preferably prescribed to be about 1 millisecond or less.

Although each oxygen sensor resistance measurement is performed first in the present preferred embodiment, the length of time from an ON/OFF switching of the heater 15 may be measured, and an oxygen sensor resistance measurement may be performed after the lapse of a predetermined period of time.

As described above, in the present preferred embodiment the heater temperature measurements in the heating mode are performed at an interval of about 30 ms, whereas the heater temperature measurements in the cooling mode are performed at an interval of about 5 ms. Such time intervals (measurement periods) may be prescribed to be any other values, so long as they are integer multiples of the period of the interrupt signal. Note that the period of the interrupt signal in the present preferred embodiment corresponds to the period (measurement interval) of oxygen concentration measurement, and may be prescribed to be a value in the range from about 3 ms to 10 ms, for example.

In order to perform a highly accurate temperature control as in the present preferred embodiment, it is preferable to prescribe the measurement period (measurement interval) of the heater temperature to be about 50 ms or less. The measurement period of the heater temperature does not need to be equal between the heating mode and the cooling mode. However, in the heating mode, use of an excessively short measurement period for the heater temperature may not be preferable because the heating time of the heater in the heating mode will become relatively short (i.e., the ON duty ratio becomes small).

As has been specifically described above, in the present preferred embodiment, the timing of changing the current supplied to the heater 15 is in synchronization with the detection operation by the gas sensing portion 12, with a time difference being maintained therebetween. Therefore, even if electrical noise frequently occurs in response to ON/OFF switching operations of the heater 15, the gas sensing portion 12 does not produce detection errors. As a result, it becomes possible to perform highly accurate gas concentration measurement while controlling the heater temperature within an appropriate range.

Moreover, the gas detection device of the present preferred embodiment is able to operate with a high detection accuracy because it detects heater temperature and appropriately controls the sensor temperature without using any special temperature detection elements. Although the present preferred embodiment illustrates using the resistance-voltage conversion circuit 32 and the resistance measurement circuit 34 in order to measure the resistance values of the heater and the gas sensor, their construction is not limited to the specific example which has been described with reference to the drawings. Furthermore, the resistance value of the heater, which changes with temperature, can also be measured by measuring the current flowing through the heater while a constant voltage is applied to the heater. Therefore, the construction of the gas detection device may be altered so as to use a resistance-current conversion circuit instead of the resistance-voltage conversion circuit 32 shown in FIG. 3. Thus, the construction which has been described with reference to FIGS. 3 to 8 only exemplifies a preferred embodiment of the present invention, and may be modified in various other manners by using known techniques.

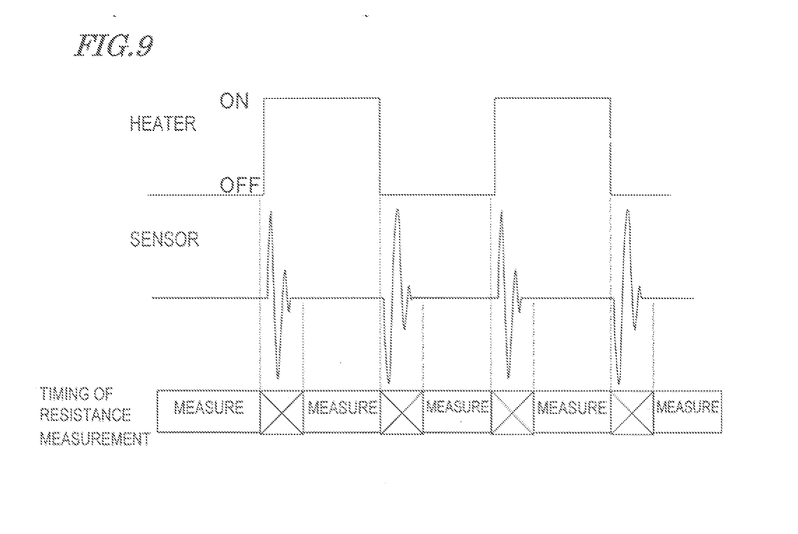

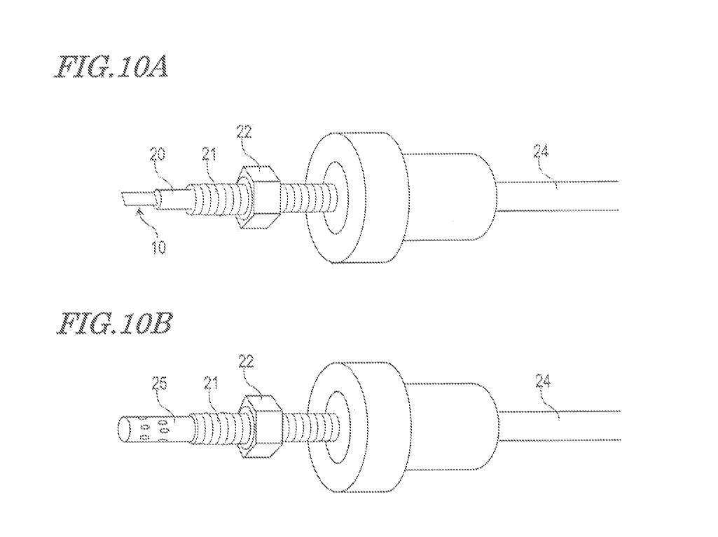

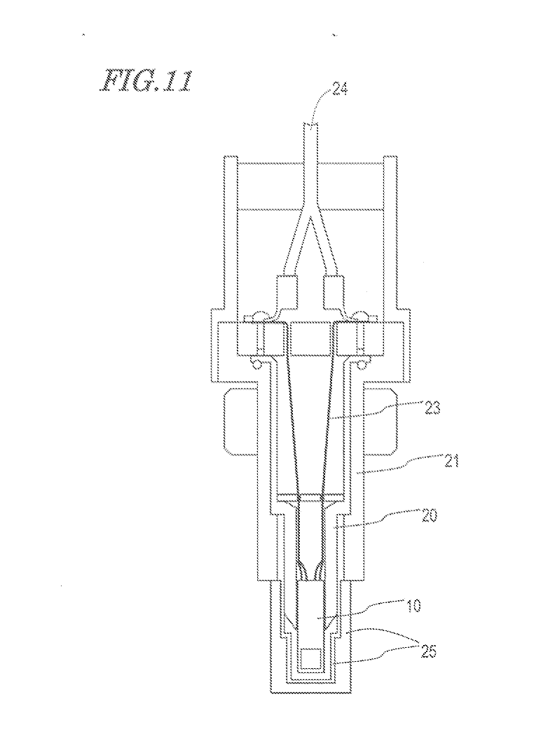

Next, with reference to FIGS. 10A, 10B, and FIG. 11, a construction for actually attaching the oxygen sensor 10 to an exhaust pipe of an internal combustion engine will be described.

At a root end of a substrate 11 (see FIGS. 1 and 2), the oxygen sensor 10 is held by a first housing 20, as shown in FIGS. 10A and 11. The first housing 20 serves to hold (affix) the substrate 11 in place and is made of a ceramic material, for example. Furthermore, the first housing 20 carrying the oxygen sensor 10 is held in place by a second housing 21. The second housing 21 is preferably made of stainless steel, for example. The surface of the second housing 21 is threaded, and the second housing 21 is affixed to an exhaust pipe with a nut 22 which engages with the threading. In actual use, as shown in FIG. 10B, a protection cap 25 is provided so as to cover the oxygen sensor 10. The result of detection by the oxygen sensor 10 is output to a control device via a detection line 24. The inside of the first housing 20 is sealed in an airtight manner by using a filler (e.g., talc powder) 23.

Although the present preferred embodiment has been illustrated with respect to a resistance-type sensor as an example, the present invention is not limited thereto, but can be used in various sensors. For example, the present invention is also applicable to a sensor using a solid electrolyte, such as that disclosed in Japanese Laid-Open Patent Publication No. 8-114571. Since a resistance-type sensor is sensitive to operating temperature, it is necessary to enhance the accuracy of measurement by frequent ON/OFF switching of the heater, which invites the problem of detection errors due to noise. Therefore, the effects according to the preferred embodiments of the present invention will be particularly prominent in a resistance-type sensor.

Moreover, the present invention is applicable to sensors for detecting various gases, without being limited to oxygen sensors. For example, the present invention is suitably used for hydrogen gas sensors or NOₓ, hydrocarbon, or organic compound sensors as disclosed in Japanese Laid-Open Patent Publication No. 2003-262599.

### Second Preferred Embodiment

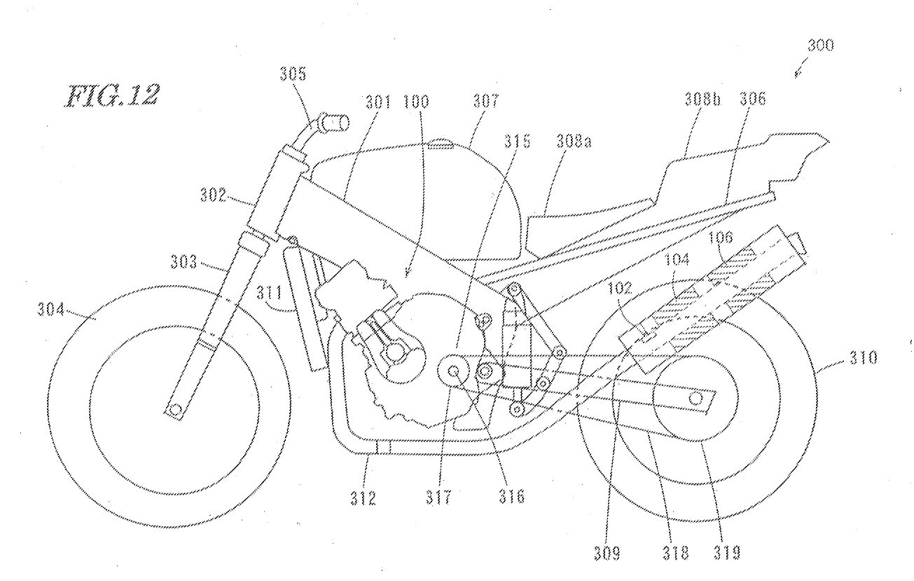

In the present preferred embodiment, a vehicle which incorporates the gas detection device described in the first preferred embodiment, and which includes an internal combustion engine as a driving source. FIG. 12 is a schematic diagram showing a motorcycle according to the present preferred embodiment. The motorcycle 300 includes a body frame 301 and an engine 100 as an internal combustion engine. A head pipe 302 is provided at the front end of the body frame 301. To the head pipe 302, a front fork 303 is attached so as to be capable of turning in the right-left direction. At the lower end of the front fork 303, a front wheel 304 is supported so as to be capable of rotating. Handle bars 305 are attached to the upper end of the head pipe 302.

A seat rail 306 is attached at an upper portion of the rear end of the body frame 301 so as to extend in the rear direction. A fuel tank 307 is provided above the body frame 301, and a main seat 308a and a tandem seat 308b are provided on the seat rail 306. Moreover, rear arms 309 extending in the rear direction are attached to the rear end of the body frame 301. At the rear end of the rear arms 309, a rear wheel 310 is supported so as to be capable of rotating.

The engine 100 is held at the central portion of the body frame 301. A radiator 311 is provided in front of the engine 100. An exhaust pipe 312 is connected to an exhaust port of the engine 100. As will be specifically described below, an oxygen sensor 102, a ternary-type catalyst 104, and a muffler 106 are provided on the exhaust pipe (in an ascending order of distance from the engine 100). As the oxygen sensor 102, the oxygen sensor 10 as described in the first preferred embodiment may be used. The surface of the sensing portion of the oxygen sensor 102 is exposed in a passage within the exhaust pipe 312 in which exhaust gas travels. Thus, the oxygen sensor 102 detects oxygen within the exhaust gas. The oxygen sensor 102 has the heater 15 as shown in FIG. 1 attached thereto. As the temperature of the gas sensing portion 12 is elevated by the heater 15 at the start of the engine 100, the detection sensitivity of the gas sensing portion 12 is enhanced. Moreover, the temperature of the gas sensing portion 12 is maintained within a predetermined range through the above-described control method, whereby an improved detection accuracy is obtained.

A transmission 315 is linked to the engine 100. Driving sprockets 317 are attached on an output axis 316 of the transmission 315. The driving sprockets 317 are linked to rear wheel sprockets 319 of the rear wheel 310 via a chain 318.

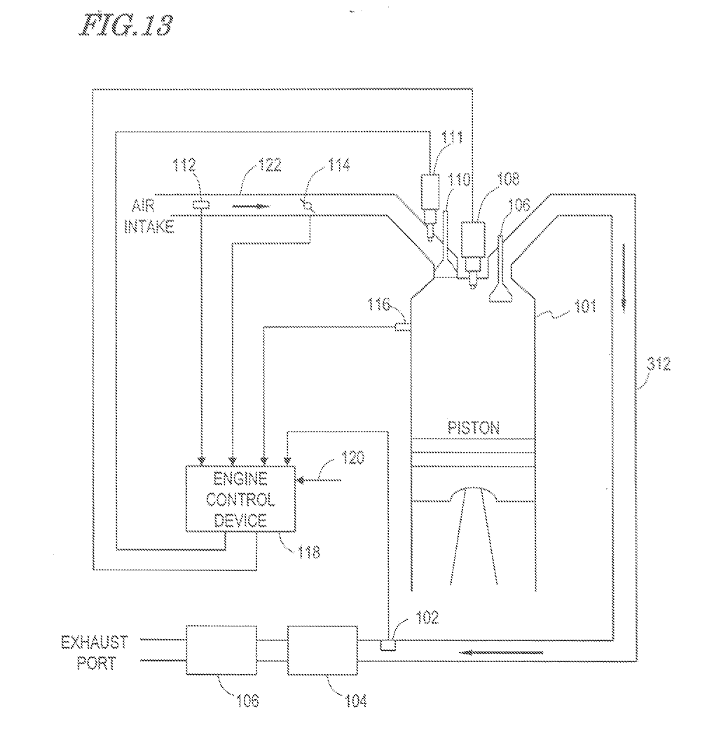

FIG. 13 shows main component elements of a control system of the engine 100. On a cylinder 101 of the engine 100, an intake valve 110, an exhaust valve 106, and a spark plug 108 are provided. There is also provided a water temperature sensor 116 for measuring the water temperature of the cooling water with which to cool the engine. The intake valve 110 is connected to an intake manifold 122, which has an air intake. On the intake manifold 122, an airflow meter 112, a throttle sensor 114 for a throttle valve, and a fuel injector 111 are provided. Thus, in the case where fuel is injected within the intake manifold 122 rather than into the combustion chamber, it is difficult to appropriately control the air-fuel ratio at the start of the engine.

The airflow meter 112, the throttle sensor 114, the fuel injector 111, the water temperature sensor 116, the spark plug 108, and the gas sensor 102 are connected to an engine control device 118, which has an internal microcomputer. A vehicle velocity signal 120, which represents the velocity of the motorcycle 300, is also input to the engine control device 118.

When a rider starts the engine 100 by using a self-starting motor (not shown), the computer calculates an optimum fuel amount based on detection signals and the vehicle velocity signal 120 obtained from the airflow meter 112, the throttle sensor 114, and the water temperature sensor 116, and based on the result of the calculation, outputs a control signal to the fuel injector 111. The fuel which is injected from the fuel injector 111 is mixed with the air which is supplied from the intake manifold 122, and injected into the cylinder 101 via the intake valve 110, which is opened or closed with appropriate timing. The fuel which is injected in the cylinder 101 combusts to become exhaust gas, which is led to the exhaust pipe 312 via the exhaust valve 106.

The oxygen in the exhaust gas is detected by the oxygen sensor 102, and more specifically by a resistance measurement circuit in the engine control device 118. The engine control device 118 determines an oxygen concentration based on the resistance value of the oxygen sensor 102, and determines the amount of deviation of the air-fuel ratio from an ideal air-fuel ratio. Then, the amount of fuel which is injected from the fuel injector 111 is controlled so as to attain the ideal air-fuel ratio relative to the air amount which is known from the signals obtained from the flowmeter 112 and the throttle sensor 114.

In the motorcycle of the present preferred embodiment, a heater which is controlled within an appropriate temperature range is included, and errors in gas detection due to the electrical noise associated with ON/OFF switching of the heater are minimized. Therefore, even in the case where the exhaust gas temperature is low at the start of the engine, or where the exhaust gas temperature fluctuates, the oxygen concentration within the exhaust gas, and changes therein, can be detected with a high detection accuracy. This ensures that fuel and air are always mixed at an appropriate air-fuel ratio, and allow the fuel to combust under optimum conditions, whereby the concentration of regulated substances (e.g., NOₓ) within the exhaust gas can be reduced. It is also possible to obtain improved mileage.

Although the present preferred embodiment has been illustrated with respect to a motorcycle for instance, the vehicle according to the present invention may be any other automotive vehicle, e.g., a four-wheeled automobile. Moreover, the internal combustion engine is not limited to a gasoline engine, but may alternatively be a diesel engine or other suitable engine.

According to the preferred embodiments of the present invention, even in the presence of noise which is associated with temperature control of the heater, it is possible to prevent detection errors of a sensor, whereby highly accurate measurements of gas concentration can be obtained. Therefore, the gas detection device, air-fuel ratio control device, and internal combustion engine according to the preferred embodiments of the present invention can be suitably used in any application where the temperature of the gas for measurement is likely to undergo substantial changes.

While the present invention has been described with respect to preferred embodiments thereof, it will be apparent to those skilled in the art that the disclosed invention may be modified in numerous ways and may assume many embodiments other than those specifically described above. Accordingly, it is intended by the appended claims to cover all modifications of the invention that fall within the true spirit and scope of the invention.

This application is based on Japanese Patent Application No. 2005-203435 filed on Jul. 12, 2005, the entire contents of which are hereby incorporated by reference.

What is claimed is:

1. A gas detection device comprising:
a gas sensing portion;
a heater;
an insulating layer provided between the gas sensing portion and the heater; and
a control section configured to control operations of the gas sensing portion and the heater so as to synchronize a timing of changing a current which is supplied to the heater with a detection operation by the gas sensing portion.

2. The gas detection device of claim 1, wherein the gas sensing portion includes a resistance-type sensor.

3. The gas detection device of claim 1, wherein the control section changes the current which is supplied to the heater in a period other than any period during which the detection operation by the gas sensing portion is executed.

4. The gas detection device of claim 3, wherein the control section selectively executes an ON operation during which power is supplied to the heater for heating or an OFF operation during which power to the heater for heating is stopped, and the timing of switching the ON/OFF operations is shifted with respect to a timing of the detection operation by the gas sensing portion.

5. The gas detection device of claim 4, wherein the control section periodically switches between the ON operation and the OFF operation during a heating mode for increasing a temperature of the heater, and executes the OFF operation during a cooling mode for decreasing a temperature of the heater.

6. The gas detection device of claim 5, wherein a period with which the ON operation and the OFF operation are switched during the heating mode is about 50 milliseconds or less.

7. The gas detection device of claim 4, wherein the control section controls the detection operation by the gas sensing portion to be periodically executed, and switches between the ON operation and the OFF operation of the heater while the detection operation is not being executed.

8. The gas detection device of claim 7, wherein the control section controls the detection operation by the gas sensing portion to be executed in response to a signal which is periodically generated, and switches between the ON operation and the OFF operation of the heater after a predetermined period of time has elapsed since the signal is generated.

9. The gas detection device of claim 7, wherein the detection operation by the gas sensing portion is executed with a period of about 10 milliseconds or less.

10. The gas detection device of claim 4, wherein an amount of time to elapse since a switching between the ON operation and the OFF operation is executed until a next instance of the detection operation by the gas sensing portion is executed is prescribed to be no less than about 500 microseconds and no more than about 2 milliseconds.

11. An air-fuel ratio control device comprising:
a gas detection device, wherein the gas detection device includes:
a gas sensing portion;
a heater;
an insulating layer provided between the gas sensing portion and the heater; and
a control section configured to control operations of the gas sensing portion and the heater so as to synchronize timing of changing a current which is supplied to the heater with a detection operation by the gas sensing portion.

12. An internal combustion engine comprising:
a gas detection device, wherein the gas detection device includes:
a gas sensing portion;
a heater;
an insulating layer provided between the gas sensing portion and the heater; and
a control section configured to control operations of the gas sensing portion and the heater so as to synchronize timing of changing a current which is supplied to the heater with a detection operation by the gas sensing portion.
